(19) United States
(12) Patent Application Publication
(10) Pub. No.: US 2011/0030132 A1
(43) Pub. Date: Feb. 10, 2011

(54) MULTI-FUNCTION CLEANOUT PLUG AND METHOD OF USE

(76) Inventor: Ladislau Biro, Metuchen, NJ (US)

Correspondence Address: WALTER J. TENCZA JR., 100 Menlo Park, Suite 210, Edison, NJ, 08837, US

(21) Appl. No.: 12/538,411

(22) Filed: Aug. 10, 2009

(51) Int. Cl. F16L 45/00; E03B 1/00

(52) U.S. Cl. 4/256.1; 137/15.01

(57) ABSTRACT

A multi-function cleanout plug and check valve for basements or other enclosed areas housing sewer cleanout plugs. An automatic drain discharge and check valve assembly housed entirely in the previously used cleanout plugs, used in sewer or other drainage systems is provided. In the event of water or other liquid accumulation due to bad weather, water line break, electrical outage, sump pump failure etc. a check valve built into a clean-out plug acts as an automatic drain through the sewer line while preventing back flow of unwanted liquid or sewer gasses.

### FIELD OF THE INVENTION

The present invention relates to providing automatic drainage of basements or other enclosed areas.

### BACKGROUND OF THE INVENTION

Cleanout plugs which are opened and closed manually have long been used in the plumbing industry to prevent sewer gasses from getting into buildings while permitting access for cleaning out clogged drain lines.

### SUMMARY OF THE INVENTION

One or more embodiments of the present invention relate to providing automatic drainage of basements or other enclosed areas. In at least one embodiment a sewer cleanout plug is provided for floor drains in basements or other enclosed areas. According to at least one embodiment of the present invention in the presence of water or other liquid accumulation, a check valve built into a cleanout plug permits automatic drainage through a sewer line while preventing back flow of liquid or unwanted gasses. One or more embodiments of the present invention provide a multi-function drain cleanout plug and check valve which is designed to replace prior art cleanout plugs.

One or more embodiments of the present invention provide an apparatus which may include a first device and a second device. The first device may be configured to attach to a pipe inlet of a pipe. The second device may be configured to allow water to flow through the first device when a threshold of water pressure is exceeded and wherein the second device is configured to prevent water from flowing through the first device when the threshold of water pressure is not exceeded. The first device may be connected to the second device.

The first device may have a handle, knob, or grip portion and an exterior threaded portion. The exterior threaded portion may be configured to be screwed into interior threads of the pipe inlet in order to attach the first device to the pipe inlet. The handle device may have one or more openings into which water can flow. The second device may include a plunger and a spring. In one or more embodiments, when the threshold of water pressure is exceeded, the plunger causes the spring to be compressed which allows water to flow through the first device, through the pipe inlet, and into the pipe. In one or more embodiments, when the threshold of water pressure is not exceeded, the plunger makes contact with a portion of the first device to provide a seal so that water cannot pass through the first device.

The second device may include a holder which is attached to the first device and which holds the plunger and the spring to the first device. The plunger may include a stem portion which is substantially surrounded by the spring.

In at least one embodiment a method is provided which includes attaching a first device to a second device, and attaching the first device to a pipe inlet of a pipe. The second device is configured to allow water to flow through the first device, through the pipe inlet and into the pipe, when a threshold of water pressure is exceeded and the second device is configured to prevent water from flowing through the first device when the threshold of water pressure is not exceeded.

### BRIEF DESCRIPTION OF THE DRAWINGS

FIG. 1A shows a cross sectional view of a prior art clean out plug inserted into a first pipe;

FIG. 1B shows a cross sectional view of a prior art clean out plug inserted into a second pipe;

FIG. 2 shows a cross sectional view of an apparatus in accordance with an embodiment of the present invention, with the apparatus shown in an assembled state;

FIG. 3A shows a cross sectional view of the apparatus of FIG. 2 inserted into a pipe in a first floor in accordance with an embodiment of the present invention;

FIG. 3B shows a cross sectional view of the apparatus of FIG. 2 inserted into a pipe in a second floor in accordance with another embodiment of the present invention;

FIG. 4 shows a perspective view of the apparatus of FIG. 2 with the apparatus shown in a disassembled state;

FIG. 5 shows another perspective view of the apparatus of FIG. 2 with the apparatus shown in a disassembled state;

FIG. 6 shows a bottom view of the apparatus of FIG. 2 with the apparatus shown in an assembled state;

FIG. 7 shows a top perspective view of the apparatus of FIG. 2 with the apparatus shown in an assembled state;

FIG. 8 shows a bottom perspective view of the apparatus of FIG. 2 with the apparatus shown in an assembled state;

FIG. 9 shows a cross sectional view of the apparatus of FIG. 2 screwed into a pipe which is located in a drainage hole or basin, with the apparatus in a closed state; and

FIG. 10 shows a cross sectional view of the apparatus of FIG. 2 screwed into the pipe which is located in the drainage hole or basin, with the apparatus in an open state.

### DETAILED DESCRIPTION OF THE DRAWINGS

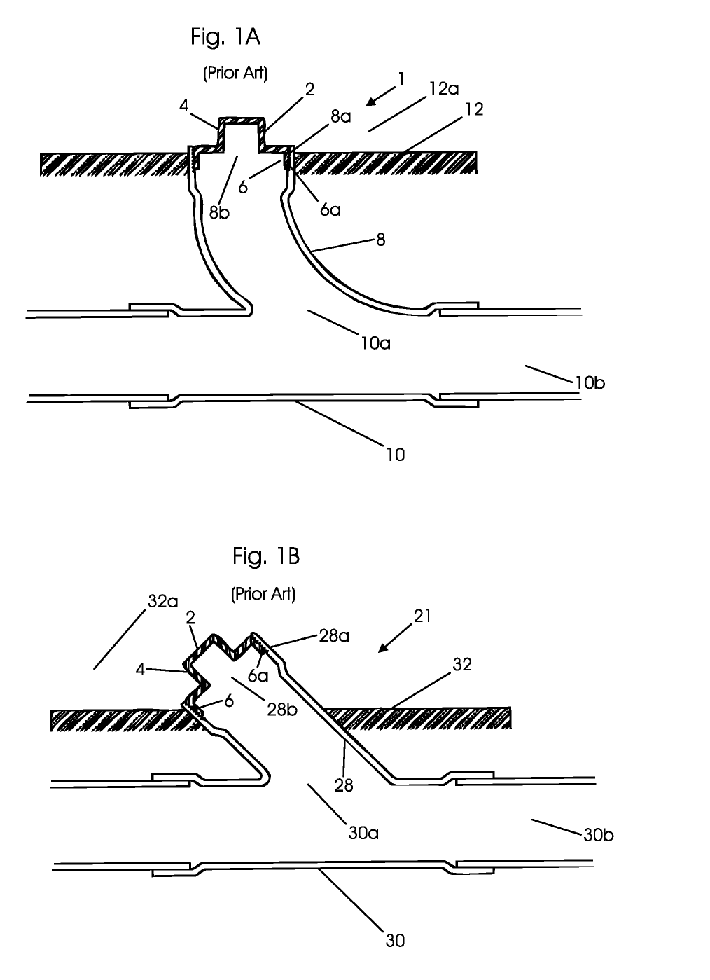

FIG. 1A shows a cross sectional view of a prior art clean out plug 2 inserted into a pipe 8. The clean out plug 2 includes a handle or knob portion 4 and a disk portion 6. The handle or knob portion may be square as known in the art. The disk portion 6 may include exterior threads or grooves 6a. The disk portion 6 may be circular or substantially circular. In FIG. 1A the plug 2 is inserted into an opening or inlet 8b of the pipe 8. The pipe 8 has interior threads or grooves 8a. The threads or grooves 6a of the plug 2 are shown screwed into the threads or grooves 8a of the pipe 8 in FIG. 1A. The plug 2 is screwed in tightly into the pipe 8 so that the plug 2 closes the opening or inlet 8b of the pipe 8 and neither liquid nor gas can pass through the opening 8b of the pipe 8. The plug 2 thereby prevents gas from escaping from the pipe 8 into the area 12a above the floor 12 and also thereby prevents liquid from entering the pipe 8 from the area 12a above the floor 12.

FIG. 1B shows a cross sectional view of the prior art clean out plug 2 inserted into a pipe 28. The pipe 28 is angled with respect to a floor 32. In FIG. 1B the plug 2 is inserted into an opening or inlet 28b of the pipe 28. The pipe 28 has interior threads or grooves 28a. The threads or grooves 6a of the plug 2 are shown screwed into the threads or grooves 28a of the pipe 28 in FIG. 1B. The plug 2 is screwed in tightly into the pipe 28 so that the plug 2 closes the opening or inlet 28b of the pipe 28 and neither liquid nor gas can pass through the opening 28b of the pipe 28. The plug 2 thereby prevents gas from escaping from the pipe 28 into the area 32a above the floor 32 and also thereby prevents liquid from entering the pipe 28 from the area 32a above the floor 32.

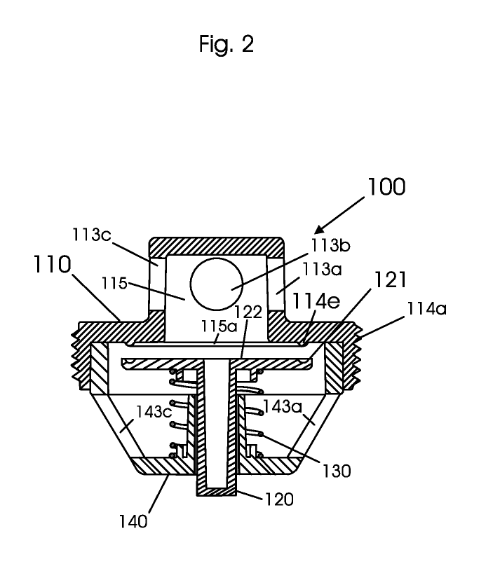

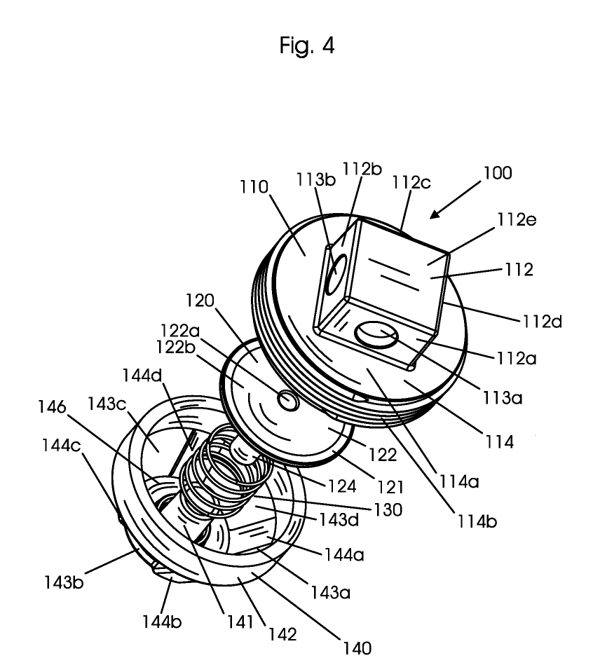

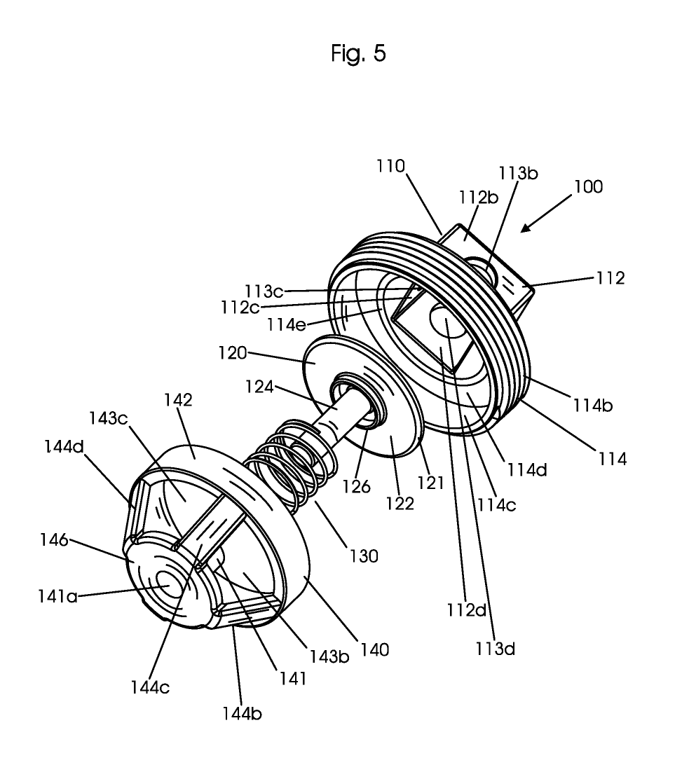

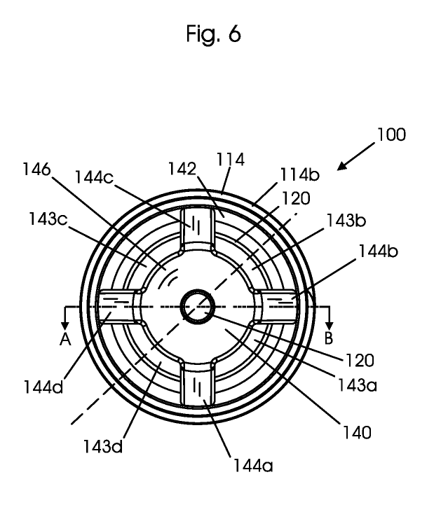

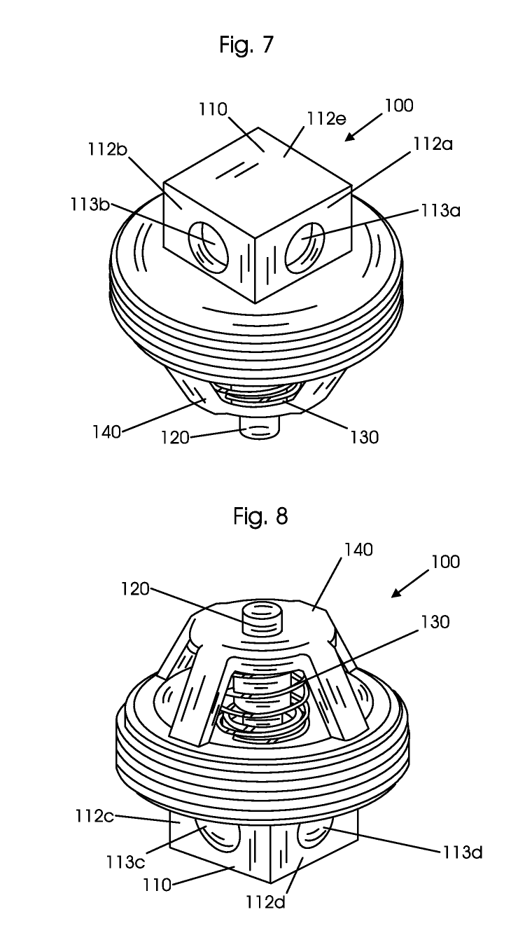

FIG. 2 shows a cross sectional view of an apparatus 100 in accordance with an embodiment of the present invention, with the apparatus 100 shown in an assembled state and in an open state. The FIG. 2 cross section may be taken along the line AB shown in FIG. 6. FIG. 4 shows a perspective view of the apparatus 100 of FIG. 2 with the apparatus shown 100 in a disassembled state. FIG. 5 shows another perspective view of the apparatus 100 of FIG. 2 with the apparatus 100 shown in a disassembled state. FIG. 6 shows a bottom view of the apparatus 100 of FIG. 2 with the apparatus 100 shown in an assembled state. FIG. 7 shows a top perspective view of the apparatus 100 of FIG. 2 with the apparatus 100 shown in an assembled state. FIG. 8 shows a bottom perspective view of the apparatus 100 with the apparatus 100 shown in an assembled state.

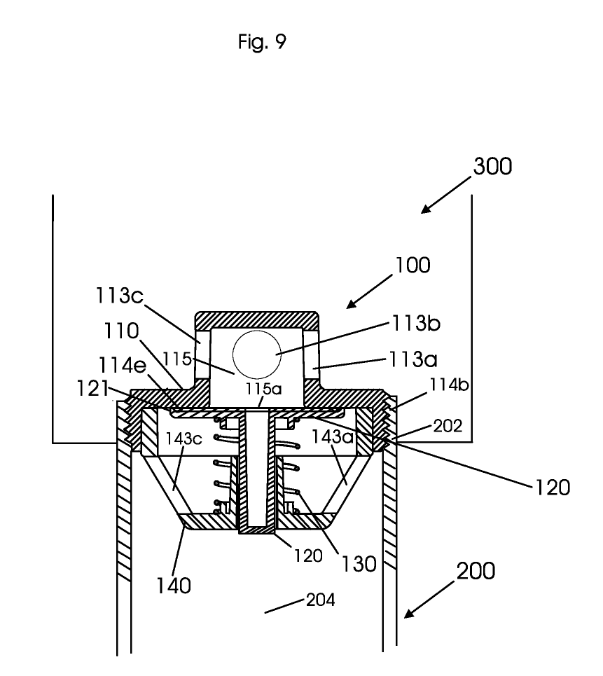

The apparatus 100 includes cap, plug, or first device 110, plunger 120, spring 130, and holder 140 as shown by FIGS. 2, 4, 5, 7, and 8. The plunger 120, spring 130, and holder 140 may together be referred to as second device or one or more of these components may be referred to as a second device. Holder 140 may be connected to the plug or cap 110, such as by glue, threads, sonic welding, snap fit, or by other means. The cap 110 may include a box portion, handle, knob, or grip section 112 having side walls 112a, 112b, 112c, and 112d, and top wall 112e, as shown by FIGS. 4, 5, 7, and 8. The side walls 112a, 112b, 112c, and 112d, may have openings 113a, 113b, 113c, and 113d, respectively. The cap 110 has a chamber 115, shown in FIG. 2, which is surrounded by walls 112a, 112b, 112c, 112d, and 112e, with the exception of openings 113a-d, and a bottom opening 115a shown in FIG. 2, which may be closed by plunger 120, as shown in FIG. 9. The cap 110 also includes a disk portion 114 to which the box portion 112 is fixed. The disk portion 114 has a top surface 114a shown in FIG. 4, a peripheral, annular wall 114c shown in FIG. 5, and external threads or grooves 114b along the exterior, annular wall 114c. The peripheral annual wall 114c may be substantially circular and may surround a chamber 114d shown in FIG. 5. Water can flow from the opening 115a of the box portion 112 into the chamber 115 when the opening 115a is not closed by plunger 120. The cap 110 also includes a ridge 114e, shown in FIG. 5, for holding the plunger 120 in place. The cap 110 may be made of polyvinyl chloride (PVC) or another plastic material.

The plunger 120 includes a disk portion 122 fixed to a stem portion 124, as shown in FIGS. 4 and 5. The disk portion 122 includes an annular rim 121 which may be circular and may have an interior diameter. The ridge 114e may also be circular and may have an outer diameter. The interior diameter of the annular rim 121 may be slightly greater than the outer diameter of the ridge 114e, so that the disk portion 122 can be placed over the ridge 144e so that the annular rim 121 snugly surrounds the ridge 114e and is held in place thereby as shown by FIG. 9. A protruding ring or ridge 126, shown in FIG. 5, is fixed to the interior of the disk portion 122. The spring 130 may be helical and may have a diameter for its bottom winding nearest the plunger disk portion 122, which allows the spring 130 to snugly fit surround the protruding ring or ridge 126, and thereby be held in place by the plunger 120.

The holder 140 includes an annular wall or ring 142, supports or brackets 144a, 144b, 144c, and 144d, and a top member or disk 146 as shown by FIGS. 4, 5, and 6. The supports or brackets 144a-d connect the top member or disk 146 with the annular wall or ring 142. The top member or disk 146 is connected to a protruding hollow tube 141, shown in FIGS. 4 and 5. The protruding hollow tube 141 has a hollow chamber 141a. One end of the spring 130 is placed so that it surrounds the tube 141, while simultaneously the other end of the spring 130 is placed so that it surrounds the step 124 and the protruding ring 126 of disk portion 122 of the plunger 120. There are openings 143a, 143b, 143c, and 143d located between supports or brackets 144a-b, 144b-c, 144c-d, and 144d and 144e, respectively as shown by FIGS. 1, 2, and 4.

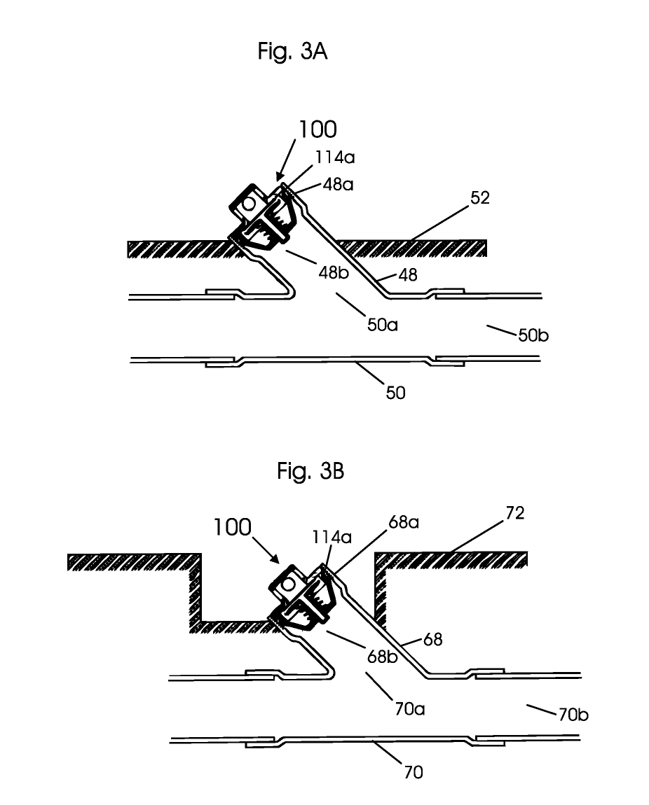

FIG. 9 shows a cross sectional view of the apparatus 100 of FIG. 1 screwed into a pipe 200 which is located in a drainage hole or basin 300, with the apparatus 100 assembled and in a closed state, so that no water passes through holes 113a-d through bottom hole 115a into a pipe chamber 204 of the pipe 200. In FIG. 7, the rim 121 of the plunger 120 surrounds the ridge 114e of the cap 110 preventing any liquid from passing through opening 115a into chamber 204 of the pipe 200. The grooves or exterior threads 114b of the cap 110 are shown screwed into interior threads or grooves 202 of the pipe 200. The apparatus 100 may also be inserted into pipes such as shown in FIGS. 3A and 3B which are at an angle to a floor surface. In FIG. 3A the apparatus 100 is inserted into an opening or inlet 48b of the pipe 48, while in FIG. 3B the apparatus 100 is inserted into an opening or inlet 68b of the pipe 68. The pipes 48 and 68 have interior threads or grooves 48a and 68a respectively. The threads or grooves 114a of the apparatus 100 are shown screwed into the threads or grooves 48a or 68a of the pipes 48 and 68 in FIGS. 3A and 3B, respectively. The apparatus 100 is screwed in tightly into the pipes 48 and 68 so that the apparatus 100, when in a closed state, closes the opening or inlets 48b and 68b of the pipes 48 and 68 and neither liquid nor gas can pass through the openings 48b and 68b. The apparatus 100, in a closed state, thereby prevents gas from escaping from the pipes 48 and 68 into the areas 52a and 72a above the floors 52 and 72 and also thereby prevents liquid from entering the pipes 48 and 68 from the areas 52a and 72a above the floors 52 and 72.

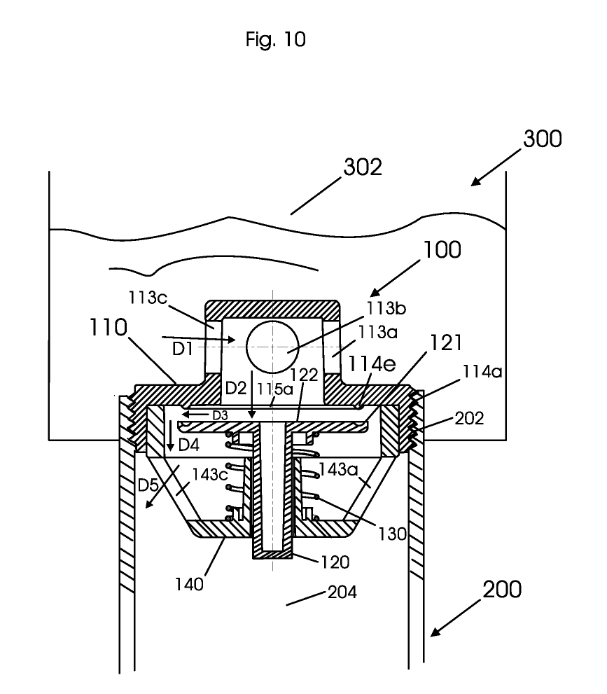

FIG. 10 shows a cross sectional view of the apparatus 100 of FIG. 2 screwed into the pipe 200 which is located in the drainage hole or basin 300 with the apparatus 100 in an open state. Note that the apparatus 100 can be placed in an open state in the configurations of FIGS. 3A and 3B, however, FIG. 10 will only be described to illustrate how water passes through the apparatus 100 into a pipe, when the apparatus 100 is in an open state.

In FIG. 10 a quantity of water 302 has been placed into the drainage hole or basin 300. The water 302 flows into the holes 113a-d, such as in the direction D1 through the hole 113c shown in FIG. 10. The water 302 pushes down on the disk portion 122 of the plunger 120 in the direction D2 shown in FIG. 10. This creates an opening between the rim 121 of the plunger 120 and the ridge 114e of the cap 110. The water 302 flows through the opening or space between ridge 114e and rim 121, such as in the direction D3, and around the plunger 120 such as in the direction D4 shown in FIG. 10. The water 302 then flows out the openings 143a-d, such as out of opening 143c in the direction D5 shown in FIG. 10. Note that in FIGS. 9 and 10, the holder 140 has been oriented so that the openings 143c and 143a can be seen to explain the flow of water out of the holder 140. Water 302 flowing out of the holder 140, such as in the direction D5, flows into the chamber 204 of the pipe 200 and from there may drain into a sewer, larger pipe or storm drain, and out of a building. For example pipe 200 may be the same as or may be replaced by pipe 48 and may flow into a sewer or larger pipe 50 as in FIG. 3A or pipe 200 may be the same as or may be replaced by pipe 68 and may flow into a sewer or larger pipe 70 as in FIG. 3B. Note that the water 302 pushing down in the direction D2 on the plunger 120 causes the spring 130 to be compressed so that the windings of the spring 130 are closer together in FIG. 10 than in FIG. 9. The spring 130 exerts a force in a direction opposite D2 so that when the water 302 has drained the spring 130 pushes the plunger 120 back into the position of FIG. 9 so that gas from the chamber 204 of the pipe 200 cannot escape from the chamber 204 through the opening 115a, since the opening 115a is closed by the plunger rim 121 and the ridge 114e.

The apparatus 100 may be considered to be a floor drain cleanout plug and check valve assembly. The apparatus 100 allows for automatic draining of liquids from a draining surface, such as drainage hole or basin 300 into an in-ground drain conduit, such as pipe 200, which may be a sewer line or may be connected to a sewer line. The spring 130 may be a stainless steel spring.

In at least one embodiment of the present invention, the rim 121 of the plunger 120 and the ridge 114e of the cap 110 may form a seal to prevent backflow of gases from the drain conduit or pipe 200 after liquid or water 302 has drained out of the basin 300 and into the pipe conduit 200. The plunger 120 may be substantially rigid.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a first device which is configured to attach to a pipe inlet of a pipe; and
a second device which is configured to allow water to flow through the first device when a threshold of water pressure is exceeded and wherein the second device is configured to prevent water from flowing through the first device when the threshold of water pressure is not exceeded; and
wherein the first device is connected to the second device.

2. The apparatus of claim 1 wherein
the first device has a handle portion and an exterior threaded portion;
wherein the pipe inlet has interior threads;
and wherein the exterior threaded portion is configured to be screwed into the interior threads of the pipe inlet in order to attach the first device to the pipe inlet.

3. The apparatus of claim 1 wherein
the handle device has a first opening.

4. The apparatus of claim 1 wherein
the second device includes a plunger and a spring;
wherein when the threshold of water pressure is exceeded, the plunger causes the spring to be compressed which allows water to flow through the first device, through the pipe inlet, and into the pipe; and
wherein when the threshold of water pressure is not exceeded, the plunger makes contact with a portion of the first device to provide a seal so that water cannot pass through the first device.

5. The apparatus of claim 4 wherein
the second device includes a holder which is attached to the first device and which holds the plunger and the spring to the first device.

6. The apparatus of claim 4 wherein
the plunger includes a stem portion which is substantially surrounded by the spring.

7. A method comprising
attaching a first device to a second device;
attaching the first device to a pipe inlet of a pipe; and
wherein the second device is configured to allow water to flow through the first device, through the pipe inlet and into the pipe, when a threshold of water pressure is exceeded and wherein the second device is configured to prevent water from flowing through the first device when the threshold of water pressure is not exceeded.

8. The method of claim 7 wherein
the first device has a handle portion and an exterior threaded portion;
wherein the pipe inlet has interior threads;
and wherein attaching the first device to the pipe inlet includes screwing exterior threaded portion of the first device into the interior threads of the pipe inlet in order to attach the first device to the pipe inlet.

9. The method of claim 7 wherein
the handle device has a first opening.

10. The method of claim 7 wherein
the second device includes a plunger and a spring;
wherein when the threshold of water pressure is exceeded, the plunger causes the spring to be compressed which allows water to flow through the first device; and
wherein when the threshold of water pressure is not exceeded, the plunger makes contact with a portion of the first device to provide a seal so that water cannot pass through the first device.

11. The method of claim 10 wherein
the second device includes a holder which is attached to the first device and which connects the plunger and the spring to the first device.

12. The method of claim 10 wherein
the plunger includes a stem portion which is substantially surrounded by the spring.
